(19) United States
(12) Patent Application Publication
(10) Pub. No.: US 2024/0046513 A1
(43) Pub. Date: Feb. 8, 2024

(54) METHOD FOR DIFFERENTIATING A SECONDARY ROAD MARKING FROM A PRIMARY ROAD MARKING

(71) Applicant: VALEO VISION, Bobigny (FR)

(72) Inventor: Christophe GRARD, Bobigny (FR)

(73) Assignee: VALEO VISION, Bobigny (FR)

(21) Appl. No.: 18/245,857

(22) PCT Filed: Jul. 28, 2021
(86) PCT No.: PCT/EP2021/071228

§ 371 Date: Mar. 17, 2023

(30) Foreign Application Priority Data
Sep. 22, 2020 (FR) FR2009569

(51) Int. Cl. G06T 7/73; G06T 7/90; G06V 20/56; G01C 21/30

(52) U.S. Cl. CPC G06T 7/74; G06T 7/90; G06V 20/588; G01C 21/30; H04N 23/90

(57) ABSTRACT

The invention relates to a method for differentiating a secondary road marking from a primary road marking, including: acquiring primary images of the environment of a vehicle to the front or to the rear by means of a primary camera, including images of the primary road marking and the secondary road marking which are located to the front or to the rear; acquiring secondary images of the environment on one side of the vehicle by means of a secondary camera, including images of the primary road marking and the secondary road marking which are located on the side, determining, by means of the primary camera, from the primary images, the primary colour of the primary road marking and the secondary colour of the secondary road marking.

### TECHNICAL FIELD

The present invention concerns a method for differentiating a secondary marking of a road on which a vehicle is situated from a primary marking of said road. It is particularly but non-limitingly applicable to motor vehicles. It also concerns a differentiation device for implementing said differentiation method.

### BACKGROUND OF THE INVENTION

In the field of motor vehicles, there are methods for detecting a road marking which comprise:
illumination of said road at the front of the motor vehicle by means of a primary camera,
acquisition by said primary camera of images of said road marking at the front of said motor vehicle,
detection by the primary camera of the marking of said road in front of the motor vehicle,
detection by a secondary camera of the marking of said road to the side of said motor vehicle,
performance of a determined function as a function of said detected road marking.

Depending on the application for which the detection method is used, the determined function performed is for example:
a function to assist said motor vehicle in parking, or
a function to assist said motor vehicle in changing lanes, or to assist in remaining within a lane.

The secondary camera is an infrared or near-infrared camera, since infrared light is invisible to the naked eye. This allows compliance with current regulations which prohibit the use of cameras using visible light to illuminate a side of the vehicle. Thus pedestrians or vehicles situated at a side of the vehicle are not dazzled by visible light and are not disturbed by said visible light.

One drawback of this prior art is that the secondary camera, which is infrared or near-infrared, does not distinguish colors. Consequently, if there are road portions with works for which there are conventional white primary road markings, which are standard road markings, and conventional yellow secondary road markings, which are temporary road markings, the secondary camera cannot distinguish between these two types of road marking and the road marking detection system cannot function correctly. Consequently, it is not known which road marking to follow in order to perform the determined function.

### SUMMARY OF THE INVENTION

In this context, the present invention concerns a method for differentiating a secondary marking of a road on which a vehicle is situated from a primary marking of said road, in order to resolve the above-mentioned drawback.

To this end, the invention proposes a method for differentiating a secondary marking of a road on which a vehicle is situated from a primary marking of said road, characterized in that said differentiation method comprises:
acquiring primary images of the external environment of said vehicle to the front or to the rear of said vehicle by means of a primary camera, said primary images comprising images of said primary road marking and said secondary road marking which are located to the front or to the rear of said vehicle,
acquiring secondary images of said external environment on at least one side of said vehicle by means of at least one secondary camera, said secondary images comprising images of said primary road marking and said secondary road marking which are located on said at least one side of said vehicle,
determining, by means of said primary camera, from said primary images, the primary color of said primary road marking,
determining, by means of said primary camera, from said primary images, the secondary color of said secondary road marking,
transmitting, by means of the primary camera to an electronic control unit, a primary position vector of the primary marking with its associated primary color, and a secondary position vector of the secondary marking with its associated secondary color, said primary position vector and said secondary position vector being inferred from said primary images,
transmitting, by means of the secondary camera to said electronic control unit, a primary position vector of the primary road marking and a secondary position vector of the secondary road marking, said primary position vector and said secondary position vector being inferred from said secondary images,
determining, by means of said electronic control unit, a relative position vector of said secondary road marking with respect to the primary road marking in the secondary field of view of the secondary camera, from said primary position vectors and said secondary position vectors,
correlating, by means of said electronic control unit, between the secondary color and said relative position vector of said secondary road marking in the secondary field of view.

Thus, as will be seen in detail below, by differentiating between the primary road marking and the secondary road marking, it is possible to know which road markings should be followed in order to perform the determined function.

According to non-limiting embodiments, said differentiation method may furthermore comprise one or more additional features taken individually or in any technically possible combination, from among those that follow.

According to a non-limiting embodiment, said relative position vector is determined with a constant angle defined between:
a primary point of a primary image at said primary road marking and a longitudinal axis of said vehicle, and
a secondary point of a primary image at said secondary road marking and a longitudinal axis of said vehicle.

According to a non-limiting embodiment, said relative position vector is determined with a variable angle defined between:
a primary point of a primary image at said primary road marking and a longitudinal axis of said vehicle, and
a secondary point of a primary image at said secondary road marking and a longitudinal axis of said vehicle.

According to a non-limiting embodiment, said differentiation method furthermore comprises:
illumination of said primary road marking and said secondary road marking at the front or rear of said vehicle, and/or
illumination of said primary road marking and said secondary road marking on at least one side of said vehicle.

According to a non-limiting embodiment, said electronic control unit forms part of the primary camera or is separate from said primary camera.

Also, a method is proposed for positioning a vehicle relative to a secondary marking of a road on which said vehicle is travelling, said road comprising a primary road marking and said secondary road marking, characterized in that said positioning method comprises:
acquiring primary images of the external environment of said vehicle to the front or to the rear of said vehicle by means of a primary camera, said primary images comprising images of said primary road marking and said secondary road marking which are located to the front or to the rear of said vehicle,
acquiring secondary images of said external environment on at least one side of said vehicle by means of at least one secondary camera, said secondary images comprising images of said primary road marking and said secondary road marking which are located on said at least one side of said vehicle,
determining, by means of said primary camera, from said primary images, the primary color of said primary road marking,
determining, by means of said primary camera, from said primary images, the secondary color of said secondary road marking,
transmitting, by means of the primary camera to an electronic control unit, a primary position vector of the primary marking with its associated primary color, and a secondary position vector of the secondary marking with its associated secondary color, said primary position vector and said secondary position vector being inferred from said primary images,
transmitting, by means of the secondary camera to said electronic control unit, a primary position vector of the primary road marking and a secondary position vector of the secondary road marking, said primary position vector and said secondary position vector being inferred from said secondary images,
determining, by means of said electronic control unit, a relative position vector of said secondary road marking with respect to the primary road marking in the secondary field of view of the secondary camera, from said primary position vectors and said secondary position vectors,
correlating, by means of said electronic control unit, between the secondary color and said relative position vector of said secondary road marking in the secondary field of view,
calculating the position of said vehicle relative to said secondary road marking as a function of said relative position vector.

A device is also proposed for differentiating a secondary marking of a road on which a vehicle is situated from a primary marking of said road, characterized in that said differentiation device comprises:
a primary camera configured to acquire primary images of the external environment of said vehicle at the front or rear of said vehicle, said primary images comprising images of said primary road marking and said secondary road marking which are located to the front or to the rear of said vehicle,
at least one secondary camera configured to acquire secondary images of said external environment on at least one side of said vehicle, said secondary images comprising images of said primary road marking and said secondary road marking which are located on said at least one side of said vehicle,
said primary camera also being configured to determine, from said primary images, the primary color of said primary road marking and the secondary color of said secondary road marking, and to transmit to an electronic control unit a primary position vector of the primary marking with its associated primary color, and a secondary position vector of the secondary marking with its associated secondary color, said primary position vector and said secondary position vector being inferred from said primary images,
said secondary camera also being configured to transmit to said electronic control unit a primary position vector of the primary road marking and a secondary position vector of the secondary road marking, said primary position vector and said secondary position vector being inferred from said secondary images,
and characterized in that said differentiation device also comprises:
said electronic control unit configured to determine a relative position vector of said secondary road marking with respect to the primary road marking in the secondary field of view of the secondary camera, from said primary position vectors and said secondary position vectors, and to make a correlation between the secondary color and said relative position vector of said secondary road marking in the secondary field of view.

### BRIEF DESCRIPTION OF DRAWINGS

The invention and its various applications will be better understood on reading the description that follows and on studying the figures which accompany it:

FIG. 1 a is a flow-chart of a method for differentiating a secondary marking of a road on which a vehicle is situated from a primary marking of said road, according to a first non-limiting embodiment of the invention,

FIG. 1b is a flow-chart of a method for differentiating a secondary marking of a road on which a vehicle is situated from a primary marking of said road, according to a second non-limiting embodiment of the invention,

FIG. 2 is a schematic view from above of a vehicle situated on a road comprising a primary road marking and a secondary road marking, according to a non-limiting embodiment,

FIG. 3 is a schematic view of a device for differentiating a secondary marking of a road on which a vehicle is situated from a primary marking of said road, said differentiation device allowing implementation of the differentiation method of FIGS. 1a and 1b, according to a non-limiting embodiment,

FIG. 4a is a schematic view from above of the vehicle from FIG. 2, said view containing points on the primary road marking and secondary road marking used to determine the position of one road marking relative to the other, according to a first non-limiting embodiment,

FIG. 4b is a schematic view from above of a primary image acquired by a primary camera of the differentiation device from FIG. 3, said primary image containing the points on the primary road marking and secondary road marking of FIG. 4a, according to a first non-limiting embodiment,

FIG. 5a is a schematic view from above of the vehicle from FIG. 2, said view containing points on the primary road marking and secondary road marking used to determine the position of one road marking relative to the other, according to a second non-limiting embodiment,

FIG. 5b is a schematic view from above of a primary image acquired by a primary camera of the differentiation device from FIG. 3, said primary image containing the points on the primary road marking and secondary road marking of FIG. 5a, according to a second non-limiting embodiment,

FIG. 6 is a flow-chart of a method for positioning a vehicle relative to a secondary marking of a road on which a vehicle is situated from a primary marking of said road, according to a non-limiting embodiment.

### DETAILED DESCRIPTION OF THE INVENTION

Elements that are identical in terms of structure or function appearing in various figures retain the same references, unless indicated otherwise.

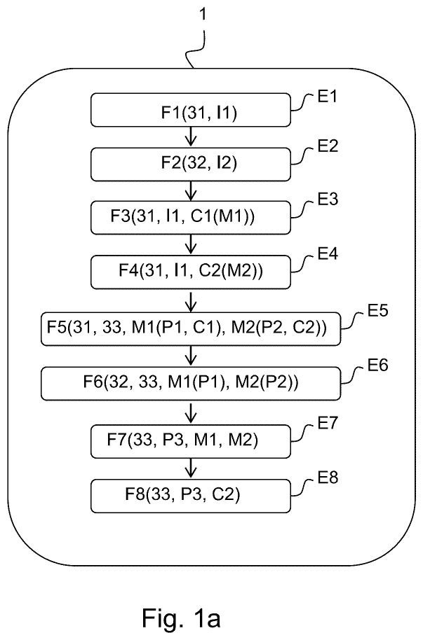

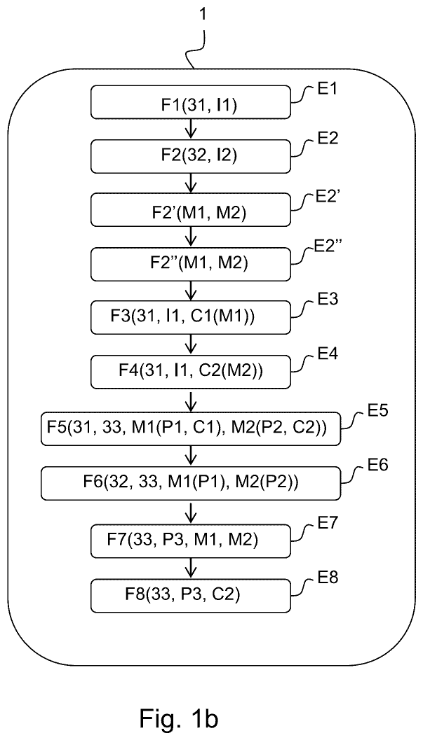

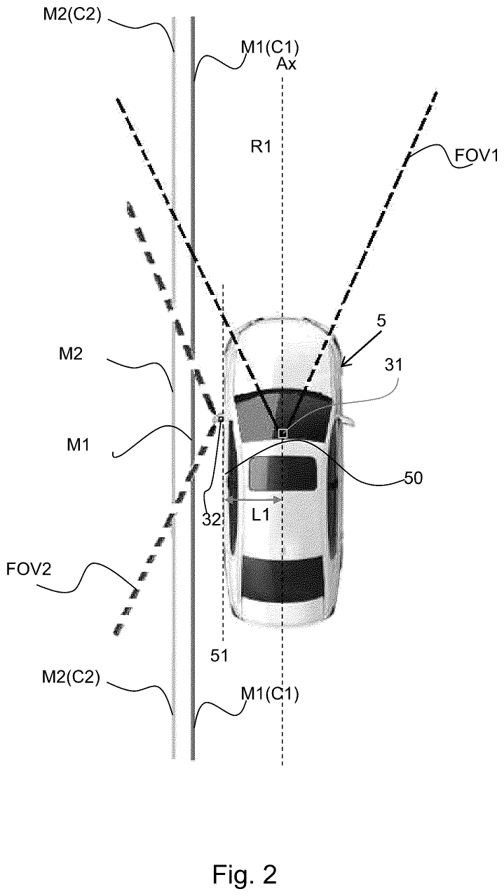

The method 1 for differentiating a secondary marking M2 of a road R1 on which a vehicle 5 is situated from a primary marking M1 of said road R1, according to the invention, is described with reference to FIGS. 1 to 5b. In one non-limiting embodiment, the vehicle 5 is a motor vehicle. By motor vehicle, what is meant is any type of motorized vehicle. This embodiment is taken as a non-limiting example throughout the remainder of the description. In the remainder of the description, the vehicle 5 is thus also called the motor vehicle 5. The motor vehicle 5 has a width L1*2 (as illustrated on FIGS. 2, 4a and 5a) and a length which extends along a longitudinal axis Ax perpendicular to a transverse axis Ay and passing through its center.

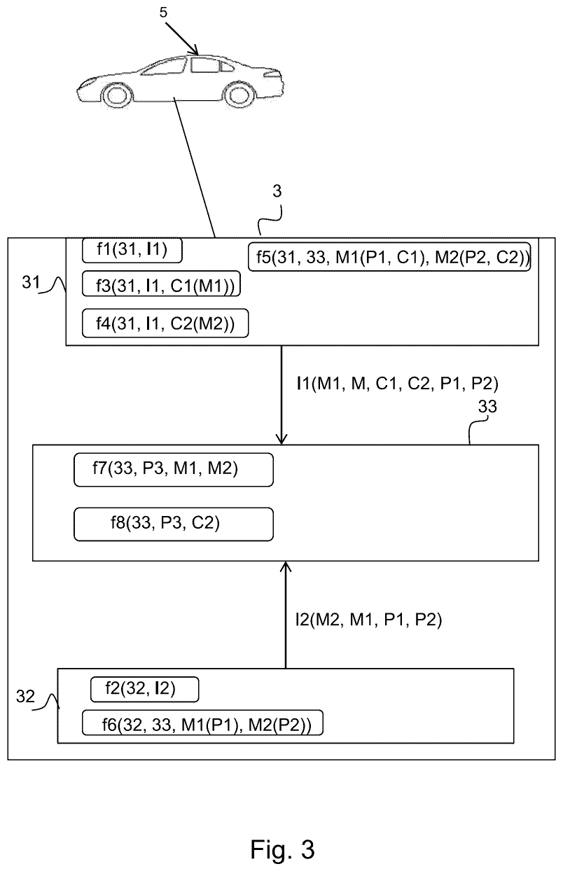

The differentiation method 1 is implemented by a differentiation device 3 illustrated on FIG. 3, which comprises:
a primary camera 31, and
at least one secondary camera 32, and
an electronic control unit 33.

The primary camera 31 is arranged at the front or rear of the motor vehicle 5, whereas said at least one secondary camera 32 is arranged on a side of the motor vehicle 5. As illustrated in the non-limiting example of FIG. 2, the primary camera 31 is situated at the front of the motor vehicle 5. In one non-limiting embodiment, it is placed behind the windscreen at the level of the rearview mirror. The primary camera 31 is a camera which functions in the visible range. The primary camera 31 is configured to acquire images in RGB colors from the exterior of the motor vehicle 5.

As illustrated in the non-limiting example of FIG. 2, the secondary camera 32 is situated on the left-hand side of the motor vehicle 5. In one non-limiting embodiment, it is arranged in a side mirror. In non-limiting embodiments, the secondary camera 32 is an infrared (wavelength between 700 nanometres and 1 millimetre) or near-infrared (wavelength around 850 nanometres), or longwave infrared LWIR (wavelength around 10 microns) or shortwave infrared SWIR camera (wavelength around one micron). The secondary camera 32 is configured to acquire infrared images from the exterior of the motor vehicle 5.

According to a non-limiting embodiment, the electronic control unit 33 forms part of the primary camera 31 or is separate from said primary camera 31. In a non-limiting embodiment (not shown), the differentiation device 3 comprises a secondary camera 32 situated on each side of the motor vehicle 5, one on the left-hand side and one on the right-hand side.

The differentiation method 1 allows differentiation between a secondary marking M2 and a primary marking M1 of a road R1 on which the motor vehicle 5 is situated. As illustrated in FIG. 2, the primary road marking M1 represents the standard marking of a road R1, while the secondary road marking M2 represents the marking relating to works on the road R1. Thus the primary road marking M1 is a permanent marking while the secondary road marking M2 is a temporary marking. The primary road marking M1 has a primary color C1 and the secondary road marking M2 has a secondary color C2. The two colors C1 and C2 are different. Thus in a non-limiting example, the primary color C1 is white (illustrated in dark color on FIG. 2) while the secondary color C2 is yellow (illustrated in lighter color on FIG. 2).

To distinguish the secondary road marking M2 from the primary road marking M1, the differentiation method 1 comprises the following steps, as illustrated on FIG. 1a, according to a first non-limiting embodiment. It is noted that certain steps are performed in parallel.

In a first step E1, illustrated as F1(31, I1) on FIG. 1a, the primary camera 31 acquires primary images I1 of an external environment at the front or rear of said motor vehicle 5. The primary images I1 thus comprise images of said primary road marking M1 and of said secondary road marking M2 situated at the front or rear of said motor vehicle 5. As illustrated in the non-limiting example of FIG. 2, the primary images I1 acquired are those of the external environment situated at the front of the motor vehicle 5. FIG. 2 illustrates the primary field of view FOV1 (in dotted lines) of the primary camera 31, the primary road marking M1 and the secondary road marking M2 seen in the primary field of view FOV1. It is noted that in this non-limiting embodiment, this step is performed continuously. Given that the primary camera 31 is a camera which functions in the visible range, the primary images I1 show the colors C1, C2 of the two primary and secondary road markings M1, M2. Thus as shown on FIG. 2, the primary road marking M1 and the secondary road marking M2 are represented with two different colors, respectively one dark and one light, in the primary field of view FOV1. The field of view of a camera is known as the field of vision.

In a second step E2, illustrated as F2(32, I2) on FIG. 1a, at least one secondary camera 32 acquires secondary images I2 of an external environment on at least one side of said motor vehicle 5. The secondary images I2 thus comprise images of said primary road marking M1 and of said secondary road marking M2 on one side of said motor vehicle 5. As illustrated in the non-limitative example of FIG. 2, the side concerned is the left-hand side of the motor vehicle 5. FIG. 2 shows the secondary field of view FOV2 (in dotted lines) of the secondary camera 32, the primary road marking M1 and the secondary road marking M2 seen in the secondary field of view FOV2. It is noted that in this non-limiting embodiment, this step is performed continuously. It is thus performed in parallel to the first step E1. Given that the secondary camera 32 is a camera which functions in the infrared or near-infrared range, the secondary images I2 do not show the colors C1, C2 of the two primary M1 and secondary road markings M2.

In a third step E3, illustrated as F3(31, I1, C1(M1)) on FIG. 1a, from said primary images I1, the primary camera 31 determines the primary color C1 (represented in dark grey on FIG. 2) of the primary road marking M1. As the primary camera 31 functions in the visible range, it can distinguish the colors from one another. In the non-limiting example illustrated, it determines that the primary color C1 of the primary road marking M1 is white.

In a fourth step E4, illustrated as F4(31, I1, C2(M2)) on FIG. 1a, from said primary images I1, the primary camera 31 determines the secondary color C2 (represented in light grey on FIG. 2) of the secondary road marking M2. In the non-limiting example illustrated, it determines that the secondary color C2 of the secondary road marking M2 is yellow (illustrated as light grey FIG. 2).

In a fifth step E5, illustrated as F5(31, 33, M1(P1, C1), M2(P2, C2)) on FIG. 1a, the primary camera 31 transmits to the electronic control unit 33 a primary position vector P1 of the primary road marking M1 with its associated primary color C1, and a secondary position vector P2 of the secondary marking M2 with its associated secondary color C2, the primary position vector P1 and the secondary position vector P2 being obtained from said primary images I1. The primary position vector P1 and secondary position vector P2 are the position relative to the motor vehicle 5, in particular relative to a line 51 tangent to the flank 50 of the motor vehicle 5.

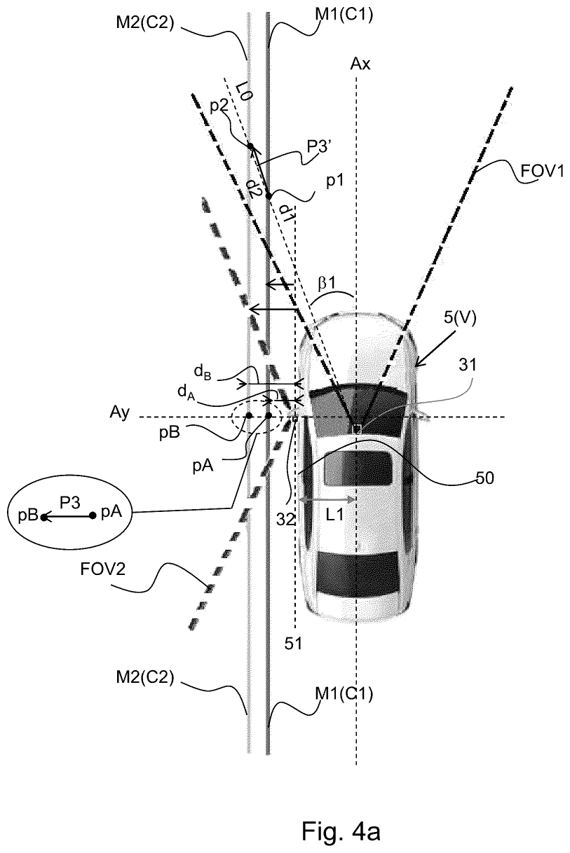

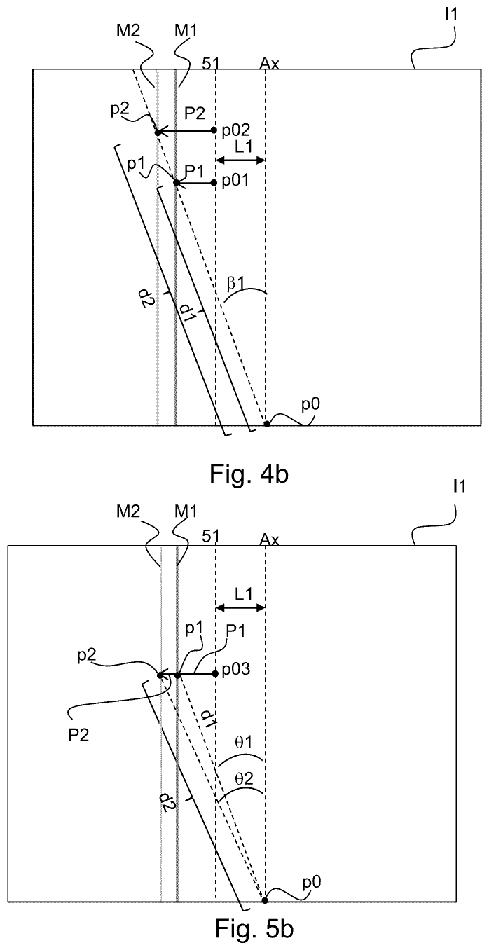

In a first non-limiting embodiment illustrated on FIGS. 4a and 4b, the primary position vector P1(p01→p1) is inferred from an angle β1 between the longitudinal axis Ax and a primary point p1 of a primary image I1 situated at the level of said primary road marking M1. We thus have:

LP1=d₁ sin β1−L1 Equation 1

With LP1 as its length, p01 as its point of origin on the line 51 tangent to the flank 50, and d1 as the distance between a center point p0 at the bottom of the primary image I1 and the primary point p1.

Similarly, in a first non-limiting embodiment illustrated on FIGS. 4a and 4b, the secondary position vector P2(p02→p2) is inferred from the same angle β1 between the longitudinal axis Ax and a secondary point p2 of a primary image I1 situated at the level of said secondary road marking M2. We thus have:

LP2=d₂ sin β1−L1 Equation 2

With LP2 as its length, p02 as its point of origin on the line 51 tangent to the flank 50, and d2 as the distance between the center point p0 at the bottom of the primary image I1 and the secondary point p2.

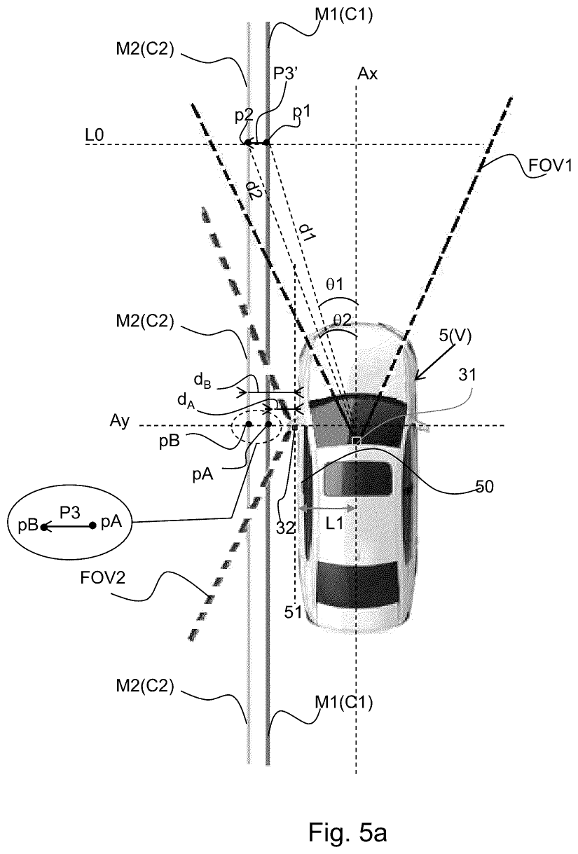

In a second non-limiting embodiment illustrated on FIGS. 5a and 5b, the primary position vector P1(p03→p1) is inferred from an angle θ1 between the longitudinal axis Ax and a primary point p1 of a primary image I1 situated at the level of said primary road marking M1. We thus have:

LP1=d₁ sin θ1−L1 Equation 3

With LP1 as its length, p03 as its point of origin on the line 51 tangent to the flank 50, and d1 as the distance between a center point p0 at the bottom of the primary image I1 and the primary point p1. The center point p0 represents the location of the primary camera 31.

Similarly, in a second non-limiting embodiment illustrated on FIGS. 5a and 5b, the secondary position vector P2(p03→p2) is inferred from an angle θ2 different from θ1 between the longitudinal axis Ax and a secondary point p2 of a primary image I1 situated at the level of said secondary road marking M2. We thus have:

LP2=d₂ sin θ2−L1 Equation 4

With LP2 as its length, p03 as its point of origin on the line 51 tangent to the flank 50, and d2 as the distance between the center point p0 at the bottom of the primary image I1 and the secondary point p2. The center point p0 represents the location of the primary camera 31. In this case, the primary point p1 and the secondary point p2 are aligned on a line perpendicular to the longitudinal axis Ax.

It is noted that, to perform the above calculations in the first embodiment and second embodiment, it is assumed that the motor vehicle 5 is travelling parallel to the lines of road markings M1, M2, which are themselves parallel.

In a sixth step E6, illustrated as F6(32, 33, M1(P1, C1), M2(P2, C2)) on FIG. 1a, the secondary camera 32 transmits to the electronic control unit 33 the primary position vector P1 of the primary road marking M1 and the secondary position vector P2 of the secondary marking M2, the primary position vector P1 and the secondary position vector P2 being obtained from said secondary images I2. The primary position vector P1 and secondary position vector P2 are the position relative to the motor vehicle 5, in particular relative to a line 51 tangent to the flank 50 of the motor vehicle 5. Thus the secondary camera 32 also transmits a primary position vector P1 and a secondary position vector P2, but seen from its viewpoint. Thus the electronic control unit 33 will receive two primary position vectors P1 (one from the primary camera 31 and the other from the secondary camera 32), and two secondary position vectors P2 (one from the primary camera 31 and the other from the secondary camera 32). The primary position vector P1 from the primary camera 31 is also known as the first primary position vector P1, and the primary position vector P1 from the secondary camera 32 is also known as the second primary position vector P1. Similarly, the secondary position vector P2 from the primary camera 31 is also known as the first secondary position vector P2, and the secondary position vector P2 from the secondary camera 32 is also known as the second secondary position vector P2.

In the same manner as for the fifth step E5, the two non-limiting embodiments illustrated in FIGS. 5a and 5b are used to determine the primary position vector P1 and the secondary position vector P2, the primary image I1 being replaced by a secondary image I2, and the center point p0 of the primary camera 31 by the center point (not shown) of the secondary camera 32.

It is noted that the primary camera 31 has transferred the primary images I1 to the electronic control unit 33, and the secondary camera 32 has transferred the secondary images I2 to the electronic control unit 33, via a suitable communication link such as, in non-limiting examples, a CAN or Ethernet link. It is noted that the primary images I1 and the secondary images I2 are refreshed as the motor vehicle 5 moves along the road R1.

In a seventh step E7, illustrated as F7(33, P3, M1, M2) on FIG. 1a, the electronic control unit 33 determines the relative position vector P3(pA→pB) of the secondary road marking M2 relative to the primary road marking M1 in the secondary field of view FOV2 from said primary position vectors P1 and said secondary position vectors P2, namely from the first primary position vector P1 and the second primary position vector P1, and from the first secondary position vector P2 and the second secondary position vector P2. Since it has received the primary position vectors P1 and the secondary position vectors P2 from the primary camera 31 and secondary camera 32, the electronic control unit 33 may infer from these the relative position vector P3′ in the primary field of view FOV1 and consequently the direction of the relative position vector P3 in the secondary field of view FOV2, towards or away from the vehicle 5.

In order to determine the relative position vector P3 in the secondary field of view FOV2, the electronic control unit 33 may perform the following calculation.

As illustrated on FIG. 4a, in a first non-limiting embodiment, the relative position vector P3′ is determined with a constant angle 131 defined between:
a primary point p1 of a primary image I1 at the level of said primary road marking M1 and a longitudinal axis Ax of said motor vehicle 5, and
a secondary point p2 of a primary image I1 at the level of said secondary road marking M2 and a longitudinal axis Ax of said vehicle 5.

The primary point p1 is at a distance d1 from the primary camera 31, and the secondary point p2 is at a distance d2 from the primary camera 31. The primary point p1 and the secondary point p2 are aligned on a line L0 which passes through the primary camera 31, intersecting the primary road marking M1 and the secondary road marking M2, and defining the angle θ1 with the longitudinal axis Ax.

As a function of the speed V of the motor vehicle 5, it is known at what instant the primary point p1 and the secondary point p2, which are in the primary field of view FOV1 of the primary camera 31, will enter the secondary field of view FOV2 of the secondary camera 32. It is thus known that the primary point p1 and the secondary point p2 seen by the primary camera 31 correspond respectively to a tertiary point pA and a quaternary point pB. These two points pA and pB are aligned on a transverse axis Ay perpendicular to the longitudinal axis Ax of the motor vehicle 5. The tertiary point pA lies are a distance dA from the motor vehicle 5, and the quaternary point pB lies at a distance dB from the motor vehicle 5 along the transverse axis Ay. Thus there is the following relation.

d_{A}=d₁ sin β1−L1=LP1 Equation 5

With LP1 as the length of the position vector P1, and

d_{B}=d₂ sin β1−L1=LP2 Equation 6

With LP2 as the length of the position vector P2.

With L1 as half the width of the motor vehicle 5. With this relation, it can be verified that the tertiary point pA and the quaternary point pB seen by the secondary camera 32 lie approximately at the distance dA and dB given by the calculation. The distance dA and the distance dB may be used to infer the relative position vector P3(pA→pB), with its length dB-dA and point of origin pA. The direction of the position vector P3 is the same as that of the position vector P3′, towards or away from the vehicle 5. Thanks to distance dA, it is known that point pA belongs to marking M1. Thanks to distance dB, it is known that point pB belongs to marking M2.

As illustrated on FIG. 5a, in a second non-limiting embodiment, the relative position vector P3′ is determined with a constant angle θ defined between:
a primary point p1 of a primary image I1 at the level of said primary road marking M1 and a longitudinal axis Ax of said motor vehicle 5, and
a secondary point p2 of a primary image I1 at the level of said secondary road marking M2 and a longitudinal axis Ax of said motor vehicle 5.

The primary point p1 is at a distance d1 from the primary camera 31, and the secondary point p2 is at a distance d2 from the primary camera 31. The primary point p1 and the secondary point p2 are aligned on a line L0 perpendicular to the longitudinal axis Ax and intersecting the primary road marking M1 and the secondary road marking M2.

As a function of the speed V of the motor vehicle 5, it is known at what instant the primary point p1 and the secondary point p2, which are in the primary field of vision FOV1 of the primary camera 31, will enter the secondary field of vision FOV2 of the secondary camera 32. It is thus known that the primary point p1 and the secondary point p2 seen by the primary camera 31 correspond respectively to a tertiary point pA and a quaternary point pB. These two points pA and pB are aligned on a transverse axis Ay perpendicular to the longitudinal axis Ax of the motor vehicle 5. The tertiary point pA lies are a distance dA from the motor vehicle 5, and the quaternary point pB lies at a distance dB from the motor vehicle 5 along the transverse axis Ay. Thus there is the following relation.

d_{A}=d₁ sin θ1−L1=LP1 Equation 7

With LP1 as the length of the position vector P1, and

d_{B}=d₂ sin θ2−L1=LP2 Equation 8

With LP2 as the length of the position vector P2.

With L1 as half the width of the motor vehicle 5. With this next relation, it can be verified that the tertiary point pA and the quaternary point pB seen by the secondary camera 32 lie approximately at the distance dA and dB given by the calculation. The distance dA and the distance dB may be used to infer the relative position vector P3, with its length dB-dA and point of origin pA. Thanks to distance dA, it is known that point pA belongs to marking M1. Thanks to distance dB, it is known that point pB belongs to marking M2.

In an eighth step E8, illustrated as F8(33, P3, C2) on FIG. 1a, the electronic control unit 33 performs a correlation between the secondary color C2 and the relative position vector P3 of said secondary road marking M2 (relative to the primary road marking M1) in the secondary field of view FOV2 (thanks to the calculated distances dA, dB) Thanks to the data transmitted by the primary camera 31, namely the primary position vector P1 with its associated primary color C1 and the secondary position vector P2 with its associated secondary color C2 seen by the primary camera 31, and the data transmitted by the secondary camera 32, namely the primary position vector P1 and the secondary position vector P2 seen by said secondary camera 32, the electronic control unit 33 may associate the secondary color C2 with the relative position vector P3.

Thus by determining the secondary color C2 of the secondary road marking M2, and its relative position vector P3 relative to the primary road marking M1, it is possible to differentiate said secondary road marking M2 from said primary road marking M1.

In a second non-limiting embodiment illustrated on FIG. 1b, in addition to the steps E1 to E8, the differentiation method 1 may also comprise the following supplementary steps:
illumination of the primary road marking M1 and the secondary road marking M2 at the front or rear of the vehicle 5 (step E2′ illustrated as F2′(M1, M2) on FIG. 1b), and/or
illumination of the primary road marking M1 and the secondary road marking M2 on at least one side of the vehicle 5 (step E2″ illustrated as F2″(M1, M2) on FIG. 1b).

The illumination is provided by a light module (not shown). The illumination is particularly useful at night. It is noted that the steps are performed at the same time as all steps E1 to E8.

The differentiation method 1 is thus implemented by a differentiation device 3 illustrated on FIG. 3.

As illustrated in FIG. 3, the differentiation device 3 comprises the elements of primary camera 31, said at least one secondary camera 32, and the electronic control unit 33.

The primary camera 31 is thus configured to:
acquire primary images I1 of the external environment of said vehicle 5 at the front or rear of said vehicle 5, said primary images I1 comprising images of said primary road marking M1 and said secondary road marking M2 which are located at the front or the rear of said vehicle 5 (function illustrated as f1(31, I1)),
determine, from said primary images I1, the primary color C1 of said primary road marking M1 (function illustrated as f3(31, I1, C1(M1))),
determine the secondary color C2 of said secondary road marking M2 (function illustrated as f4(31, I1, C2(M2))),
transmit to the electronic control unit 33 the primary position vector P1 of the primary road marking M1 with its associated primary color C1, and the secondary position vector P2 of the secondary marking M2 with its associated secondary color C2, said primary position vector P1 and said secondary position vector P2 being inferred from said primary images I1 (function illustrated as f5(31, 33, M1(P1, C1), M2(P2, C2))).

Said at least one secondary camera 32 is configured to:
acquire secondary images I2 of said external environment on at least one side of said vehicle 5, said secondary images I2 comprising images of said primary road marking M1 and said secondary road marking M2 which are located on said at least one side of said vehicle 5 (function illustrated as F2(32, I2)),
transmit to the electronic control unit 33 the primary position vector P1 of the primary road marking M1 and the secondary position vector P2 of the secondary marking M2, said primary position vector P1 and said secondary position vector P2 being inferred from said secondary images I2 (function illustrated as f6(32, 33, M1(P1), M2(P2))).

Said electronic control unit 33 is configured to:
determine the relative position vector P3 of said secondary road marking M2 with respect to the primary road marking M1 in the secondary field of view FOV2 of the secondary camera 32, from said primary position vectors P1 and said secondary position vectors P2 (function illustrated as f7(33, P3, M1, M2)),
make a correlation between the secondary color C2 and said relative position vector P3 of said secondary road marking M2 in the secondary field of view FOV2 (function illustrated as f8(33, P3, C2)).

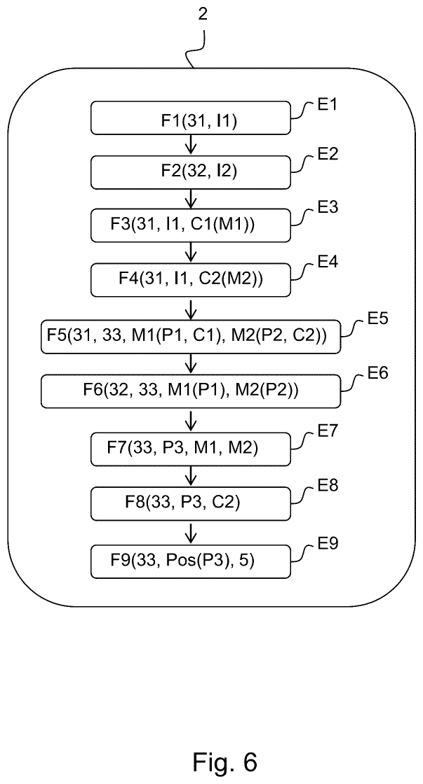

The differentiation method 1 may thus be used by any other process requiring differentiation between the primary road marking M1 and the secondary road marking M2, in particular when using a secondary camera 32 which cannot differentiate the two road markings. Thus it may be used for a method 2 of positioning a vehicle 5 relative to a secondary marking M2 of a road R1 on which the vehicle 5 is travelling. Said positioning method 2 is illustrated in FIG. 6. It comprises the steps E1 to E8 of the differentiation process 1 and the following additional steps.

In a ninth step E9, illustrated as F9(33, Pos(P3), 5), the electronic control unit 33 calculates the position Pos of the motor vehicle 5 relative to said secondary road marking M2 as a function of said relative position vector P3 of said secondary road marking M2. This position Pos is thus inferred from the distance dB previously calculated. Thus the position of the motor vehicle 5 relative to the road marking M2 is determined.

Following calculation of the position Pos, as a function of the desired application, a determined function is performed.

In non-limiting embodiments, the determined function performed is:
a function for automatic parking of said motor vehicle 5 in the case of an autonomous vehicle,
a function for assisting said motor vehicle 5 to park in the case of a non-autonomous vehicle in a roadworks zone,
a function for automatically changing lane in the case of an autonomous vehicle,
a function for displaying on a man-machine interface the color of the road marking at the side of the vehicle, instead of a black and white display,
a function for assisting with changing lanes, assistance with remaining in lane in roadworks zones etc.

It will be appreciated that the description of the invention is not limited to the embodiments described above and to the field described above. Thus in a non-limiting embodiment, the positioning method 2 may also comprise illumination of the primary road marking M1 and the secondary road marking M2 at the front or rear of the vehicle 5, and illumination of the primary road marking M1 and the secondary road marking M2 on at least one side of the vehicle 5. It is noted that on the figures, the standard road marking is on the right of the temporary road marking. Naturally the reverse may apply. In this case, the secondary road marking M2 will be on the right of the primary road marking M2. Thus in a non-limiting embodiment, the differentiation device 3 may comprise two secondary cameras 32, each arranged on one side of the motor vehicle 5, for acquiring secondary images I2 on each side of the motor vehicle 5. Thus in another non-limiting embodiment, the primary camera 31 may be arranged at a location other than behind the central review mirror. Similarly, in another non-limiting embodiment, the secondary camera 32 may be arranged at a location other than in the side mirror.

Thus, the invention described has the following advantages in particular:
it allows differentiation of a secondary road marking M2 from a primary road marking M1, thanks in particular to its color, and establishing of the location of the secondary road marking M2 relative to the primary road marking M1,
it allows inference of the position Pos of the vehicle 5 relative to the primary road marking M1 and to the secondary road marking M2, and thus establishes which road marking to follow.

What is claimed is:

1. A method for differentiating a secondary marking of a road on which a vehicle is situated from a primary marking of the road, comprising:
acquiring primary images of the external environment of the vehicle to the front or to the rear of the vehicle by means of a primary camera, the primary images includes images of the primary road marking and the secondary road marking which are located to the front or to the rear of the vehicle,
acquiring secondary images of the external environment on at least one side of the vehicle by means of at least one secondary camera, the secondary images includes images of the primary road marking and the secondary road marking which are located on the at least one side of the vehicle,
determining, by means of the primary camera, from the primary images, the primary color of the primary road marking,
determining, by means of the primary camera, from the primary images, the secondary color of the secondary road marking,
transmitting, by means of the primary camera to an electronic control unit, a primary position vector of the primary marking with its associated primary color, and a secondary position vector of the secondary marking with its associated secondary color, the primary position vector and the secondary position vector being inferred from the primary images,
transmitting, by means of the secondary camera to the electronic control unit, a primary position vector of the primary road marking and a secondary position vector of the secondary road marking, the primary position vector and the secondary position vector being inferred from the secondary images,
determining, by means of the electronic control unit, a relative position vector of the secondary road marking with respect to the primary road marking in the secondary field of view of the secondary camera from the primary position vectors and the secondary position vectors,
correlating, by means of the electronic control unit, between the secondary color and the relative position vector of the secondary road marking in the secondary field of view.

2. The differentiation method as claimed in claim 1, wherein the relative position vector is determined with a constant angle defined between:
a longitudinal axis of the vehicle, and
a half line having, as its point of origin, a center point at the bottom of a primary image, and passing through a primary point of the primary image at the level of the primary road marking and through a secondary point of the primary image at the level of the secondary road marking.

3. The differentiation method as claimed in claim 1, wherein the relative position vector is determined with a variable angle defined by two values, of which:
the one value is defined between a longitudinal axis of the vehicle and a half line having, as its point of origin, a center point at the bottom of a primary image, and passing through a primary point of the primary image at the level of the primary road marking, and
the other value is defined between a longitudinal axis of the vehicle and a half line having the center point as its point of origin, and passing through a secondary point of the primary image at the level of the secondary road marking, the primary point and the secondary point being aligned along a line perpendicular to the longitudinal axis of the vehicle.

4. The differentiation method as claimed in claim 1, further comprising:
illumination of the primary road marking and the secondary road marking at the front or rear of the vehicle, and/or
illumination of the primary road marking and the secondary road marking on at least one side of the vehicle.

5. The differentiation method as claimed in claim 1, wherein the electronic control unit forms part of the primary camera or is separate from the primary camera.

6. A method for positioning a vehicle relative to a secondary marking of a road on which the vehicle is travelling, the road including a primary road marking and the secondary road marking, comprising:
acquiring primary images of the external environment of the vehicle to the front or to the rear of the vehicle by means of a primary camera, the primary images includes images of the primary road marking and the secondary road marking which are located to the front or to the rear of the vehicle,
acquiring secondary images of the external environment on at least one side of the vehicle by means of at least one secondary camera, the secondary images includes images of the primary road marking and the secondary road marking which are located on the at least one side of the vehicle,
determining, by means of the primary camera, from the primary images, the primary color of the primary road marking,
determining, by means of the primary camera, from the primary images, the secondary color of the secondary road marking,
transmitting, by means of the primary camera to an electronic control unit, a primary position vector of the primary marking with its associated primary color, and a secondary position vector of the secondary marking with its associated secondary color, the primary position vector and the secondary position vector being inferred from the primary images,
transmitting, by means of the secondary camera to the electronic control unit, a primary position vector of the primary road marking and a secondary position vector of the secondary road marking, the primary position vector and the secondary position vector being inferred from the secondary images,
determining, by means of the electronic control unit, a relative position vector of the secondary road marking with respect to the primary road marking in the secondary field of view of the secondary camera, from the primary position vectors and the secondary position vectors,
correlating, by means of the electronic control unit, between the secondary color and the relative position vector of the secondary road marking in the secondary field of view,
calculating the position of the vehicle relative to the secondary road marking as a function of the relative position vector.

7. A device for differentiating a secondary marking of a road on which a vehicle is situated from a primary marking of the road, comprising:
a primary camera configured to acquire primary images of the external environment of the vehicle at the front or rear of the vehicle, the primary images includes images of the primary road marking and the secondary road marking which are located to the front or to the rear of the vehicle,
at least one secondary camera configured to acquire secondary images of the external environment on at least one side of the vehicle, the secondary images includes images of the primary road marking and the secondary road marking which are located on the at least one side of the vehicle,
the primary camera also being configured to determine, from the primary images, the primary color of the primary road marking and the secondary color of the secondary road marking, and to transmit to an electronic control unit a primary position vector of the primary marking with its associated primary color, and a secondary position vector of the secondary marking with its associated secondary color, the primary position vector and the secondary position vector being inferred from the primary images,
the secondary camera also being configured to transmit to the electronic control unit a primary position vector of the primary road marking and a secondary position vector of the secondary road marking, the primary position vector and the secondary position vector being inferred from the secondary images,
and
wherein the differentiation device also includes:
the electronic control unit configured to determine a relative position vector of the secondary road marking with respect to the primary road marking in the secondary field of view of the secondary camera, from the primary position vectors and the secondary position vectors, and to make a correlation between the secondary color and the relative position vector of the secondary road marking in the secondary field of view.
